(19) United States
(12) Patent Application Publication
(10) Pub. No.: US 2025/0306198 A1
(43) Pub. Date: Oct. 2, 2025

(54) RADAR-BASED HUMAN ACTIVITY RECOGNITION

(71) Applicant: Koko Home, Inc., Los Angeles, CA (US)

(72) Inventors: Luca Rigazio, Lost Gatos, CA (US); Rajiv Samir Bhan, Mountain View, CA (US); Andrew Ritter, Sunnyvale, CA (US); Jens Faenger, Lakewood Ranch, FL (US); James B. Edwards, Sunnyvale, CA (US)

(21) Appl. No.: 19/092,408

(22) Filed: Mar. 27, 2025

Related U.S. Application Data
(60) Provisional application No. 63/571,489, filed on Mar. 29, 2024.

(51) Int. Cl. G01S 13/89; G01S 7/41; G01S 13/06; G06F 40/30

(52) U.S. Cl. CPC G01S 13/89; G01S 7/412; G01S 13/06; G06F 40/30

(57) ABSTRACT

A method for determining objects in a living environment includes receiving signals from a sensor array over a predetermined time period, analyzing the signals to determine a candidate object based on variables including time, observed location, observed action, and audio, generating a confirmation question related to the determined candidate object using a large language model, presenting the confirmation question to a person, receiving an answer from the person, evaluating the answer using the large language model to confirm whether the determination of the candidate object was correct, and updating an electronic map of the living environment according to the evaluation.

### CROSS REFERENCE TO RELATED APPLICATIONS

This application claims priority to and incorporates by reference U.S. Patent Application No. 63/571,489 filed Mar. 28, 2024.

### TECHNICAL FIELD

This disclosure relates generally to radar, and more particularly, but not exclusively to radar-based human activity recognition to confirm a human has performed a task.

### BACKGROUND

Radar is a system that uses radio waves to determine the distance (ranging), direction (azimuth and elevation angles), and radial velocity of objects relative to the system that emits the radio waves.

### BRIEF SUMMARY

In one aspect, a method of confirming human activity with a sensor, includes determining a trigger associated with a task has been met, and determining, with the sensor, that a human has performed the task.

In another aspect, a method for determining objects in a living environment, includes receiving signals from a sensor array over a predetermined time period, analyzing the signals to determine a candidate object based on variables including time, observed location, observed action, and audio, generating a confirmation question related to the determined candidate object using a large language model, presenting the confirmation question to a person, receiving an answer from the person, evaluating the answer using the large language model to confirm whether the determination of the candidate object was correct, and updating an electronic map of the living environment according to the evaluation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an environment in which a system operates.

FIG. 2 is a diagrammatic representation of a processing environment, in accordance with some examples.

FIG. 3 is a block diagram showing a software architecture within which the present disclosure may be implemented, according to some examples.

FIG. 4 is a diagrammatic representation of a machine in the form of a computer system within which a set of instructions may be executed for causing the machine to perform any one or more of the methodologies discussed herein, in accordance with some examples.

FIG. 5 illustrates a routine in accordance with one example.

FIG. 6 illustrates a routine for determining a person's position in a living environment, in accordance with one example.

FIG. 7 illustrates a routine in accordance with one example.

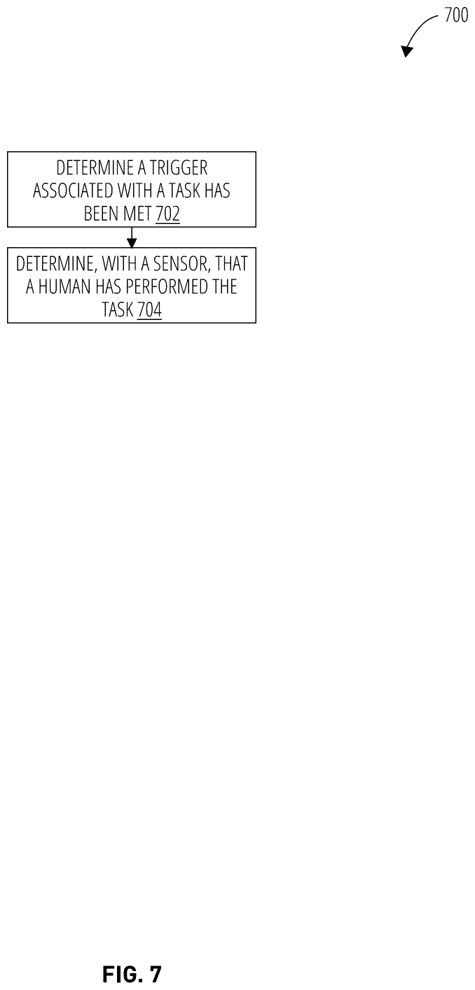

### DETAILED DESCRIPTION

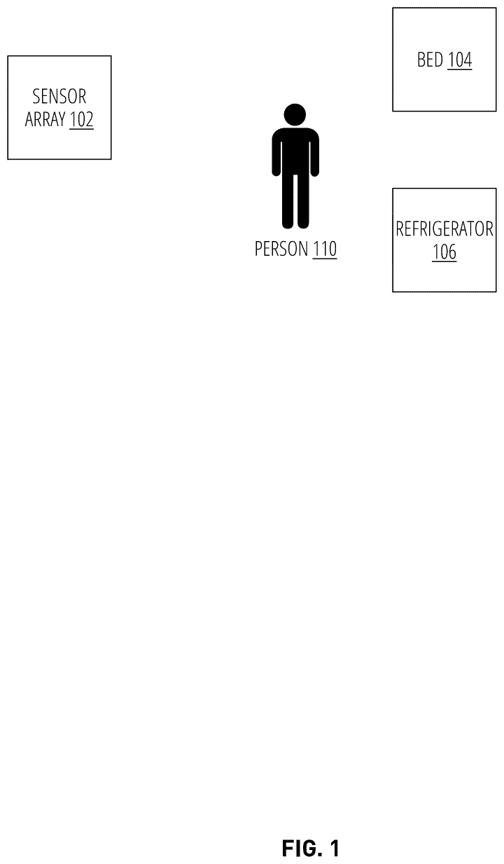

FIG. 1 illustrates an environment in which a system operates. FIG. 1 depicts a living environment containing several elements:
a bed 104;
a sensor array 102;
a person 110; and
a refrigerator 106.

Note that the environment can include other rooms and elements such as a bathroom, kitchen, toilet, pots and pans, stovetop, etc.

The sensor array 102 is positioned within the living environment to receive signals over a predetermined time period from various objects and the person within the space. This sensor array, which may include radar sensors, collects data about the environment including point clouds from radar returns that represent observed locations.

The system analyzes these signals to determine candidate objects (such as the bed 104 and refrigerator 106) based on variables including time, observed location, observed action, and audio. For example, the system can determine that object 104 is a bed by detecting patterns of the person 110 lying down in the same location over multiple nights, potentially correlated with characteristic audio such as snoring.

Similarly, the system can identify the refrigerator 106 based on the person's interactions with it and associated audio signatures. Once these objects are determined, the system can generate confirmation questions using a large language model to verify its determinations, such as asking “how was your sleep” after the person wakes up from the bed 104.

The sensor array 102 mapping capabilities enable the system to create and update an electronic map of the living environment according to evaluations of the person's responses to confirmation questions. This mapping functionality enables the system's ability to detect trigger events associated with confirmed objects and initiate appropriate tasks in response to these triggers.

The arrangement shown in FIG. 1 provides the foundation for the methods described in the routine 502, routine 600 and routine 700, where the sensor array monitors the environment to determine objects, confirm their identity through user interaction, and build a map of the living space.

In an example, the sensor array 102 continuously monitors the environment and is programmed with a list of tasks to complete, with each task associated with specific triggers. These triggers can include time-based events, user location (such as the person 110 approaching the bed 104), or actions performed by the person 110 (such as entering the room, leaving the bed, sitting down, waking up, or turning on/off lights).

When a trigger condition is met, such as when “person 110 leaves the bed after 8 am,” the sensor array 102 activates and initiates the associated task sequence. For example, if a morning medication task is triggered when the person 110 gets out of bed 104 after a certain time, the system would:
1. Inform the person 110 through a speaker or display about the task they need to perform
2. Use its radar sensing capabilities to determine whether the person 110 has performed the required task
3. Monitor if the person 110 is operating any necessary device (like taking medication from a cabinet near the refrigerator 106)

The sensor array 102 can determine task completion through various means:
Using radar or camera if the task involves interaction with another device in proximity
Using object detection or room mapping to understand if the person 110 has reached a specific location
Monitoring specific movements or motions such as the person 110 moving to another location, sitting or standing up, or performing specific exercises

If the person 110 ignores the task prompt, the system will repeat it at a later point when the same trigger conditions are met again, such as when the person 110 returns to the room.

The system records task completion (or lack thereof), activities performed, measurements taken, and responses given, making this information available to be shared with other users who can then modify or add tasks for the first user.

This functionality enables the sensor array 102 to not only map the living environment but also actively monitor and confirm human activity related to specific tasks, creating an interactive system that supports users in staying organized or managing their health.

In another example, the sensor array 102 is positioned to receive signals from throughout the living environment, capturing data about the person 110 and objects like the bed 104 and refrigerator 106. The system analyzes these signals based on variables including time, observed location, observed action, and audio to determine the person 110's position relative to objects like the bed 104. Once the system determines the person's position (such as lying on bed 104 or opening the refrigerator 106), it generates contextually relevant questions. The system presents these questions to person 110, such as asking about sleep quality after detecting the person waking from BED 104. The system receives the person 110 response. The system evaluates the response to confirm whether its determination of the person's position was correct. Based on this evaluation, the system updates its electronic map of the living environment, tracking the person 110 position in relation to objects like the bed 104 and the refrigerator 106

This functionality enables the system to accurately track the PERSON 110's movements and positions throughout the living environment, creating a dynamic understanding of how they interact with objects like the bed 104 and refrigerator 106, which may enable trigger-based task monitoring described in routine 700.

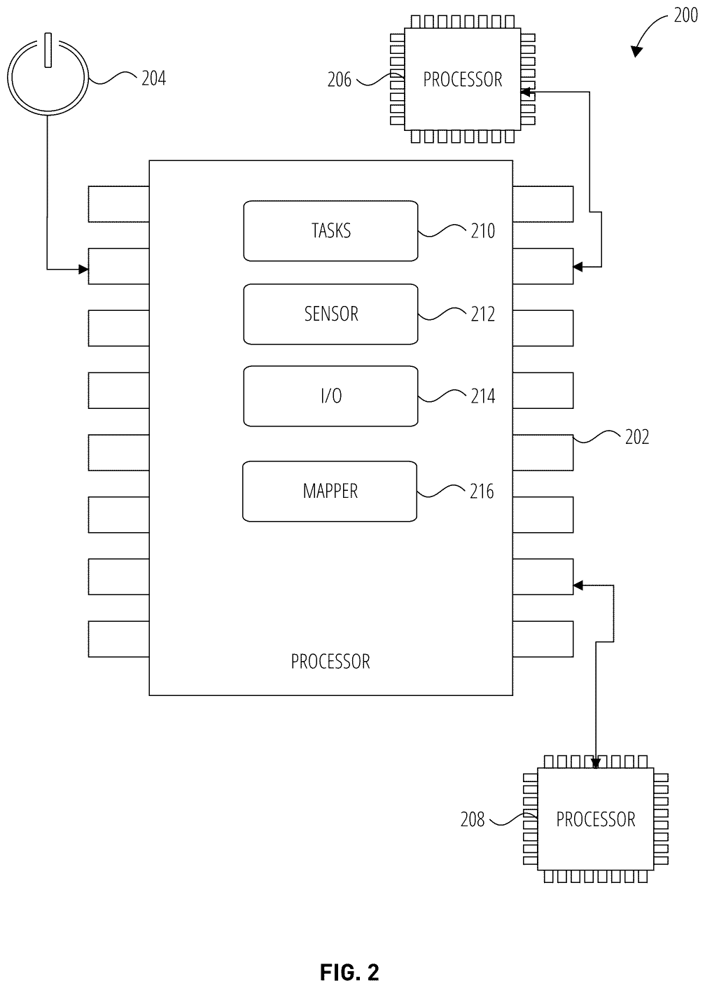

Turning now to FIG. 2, a diagrammatic representation of a processing environment 200 is shown, which includes the processor 206, the Processor 208, and a Processor 202 (e.g., a GPU, CPU, or combination thereof).

The Processor 202 is shown to be coupled to a power source 204, and to include (either permanently configured or temporarily instantiated) modules, namely a tasks 210, a sensor 212, an I/O 214, and a mapper 216. The tasks 210 operationally confirms tasks are completing using the sensor module 112 using I/O components 402 that may include radar, vision sensor, audio etc., and the I/O 214 operationally receives aural input from a user and displays or speaks instructions related to the tasks to be performed per tasks 210. As illustrated, the Processor 202 may also be communicatively coupled to both the processor 206 and Processor 208.

A processing environment 200 supports users to stay organized or manage their health by scheduling and reminding them of tasks they need to do an confirming the tasks are performed using sensor date. The task list can be e.g. a care plan from a medical provider. This task list contains activities/action from the user throughout the day.

Possible action:
1. perform specific activities using other devices, such as measuring vital signs or other medical information
2. perform specific movements or motions, such as performing a breathing exercise or moving to another part of a room or another room
3. answer questions in a dialog

The processing environment 200 uses a speaker or display to instruct the user about these activities. It then uses radar, camera or other wired or wireless sensors to record that 1 and 2 took place. The device uses a microphone to record answers to questions asked in 3.

The processing environment 200 will surface information about 1. and 2. taking place and the answers to 3. to the same or other user at a later step in time.

### Task Triggering

The processing environment 200 has a list of tasks to complete. Each task is associated with triggers. These can be time, user location, or actions performed by the user such as entering the room, leaving the bed, sitting down on a couch, waking up, turning on/off the light or others as detected by a sensor, e.g., radar. Also a combination of these, such as “user leaves the bed after 8 am”

### Perform Activities Using Other Devices

The processing environment 200 informs the user through a speaker or display about an activity they need to perform potentially using another device. This might involve directing the user to go to a different location.

The processing environment 200 then determines whether the user is operating the other device. This is done through:

Camera or radar if the 2nd device is in proximity of the processing environment 200. For this purpose, the processing environment 200 uses object detection or using a map of the room to understand where the 2nd device or user is located and if the user has reached that location.

By using a wireless or wired connection between both devices to determine if the user operated the device and in case of measurement devices, determine the value that was measured

If the other device is located outside the sensing range of the processing environment 200, the processing environment 200 will instruct the user and then use its sensors to determine if the user is going towards the other device and later comes back. Once the user comes back, the processing environment 200 will ask the user if they have completed the activity and ask about the measured values.

### Perform Specific Movements or Motions

The processing environment 200 informs the user through a speaker or display about a movement or motion they need to perform. This can be e.g. moving to another location, sitting or standing up, moving their arms in specific patterns, exercising, stretching, or breathing in specific ways.

The device is then using it's built-in wireless sensing functionality to monitor if the user is performing these movements. Further, the processing environment 200 can also use its radar to measure vital signs, generate a PPG waveform, etc. For example, the processing environment 200 may measure vital signs at rest and then instruct the user to perform an exercise and measure vital signs during and/or after the exercise. Alternatively, a trigger may be a time to measure vitals signs, etc. using radar without the need to inform the user first.

### Answer Questions in a Dialog

The processing environment 200 asks the user questions through a speaker or display. These can be about their day or their well-being such as checking for medical symptoms

The processing environment 200 records the responses from the user.

### Keep Reminding the User

When the user is asked to perform these tasks above but ignores this, the processing environment 200 will repeat it at a later point, when the same trigger conditions are met, e.g. when the user comes back into the room after leaving it.

### Record Information and Share With Other Users

Task completion (or lack of), activities performed, measurements taken and responses given are all recorded by the device either locally or on a remote storage device. This information will then be available to be displayed/shared with a second user. The second user will then be able to to modify/add tasks for the first user.

### Additional Examples

The processing environment 200 captures data from a 3rd party IoT device. The processing environment 200 analyzes the recorded values and if they are out of the expected range, triggers a voice message through the processing environment 200 with additional tasks for the user.

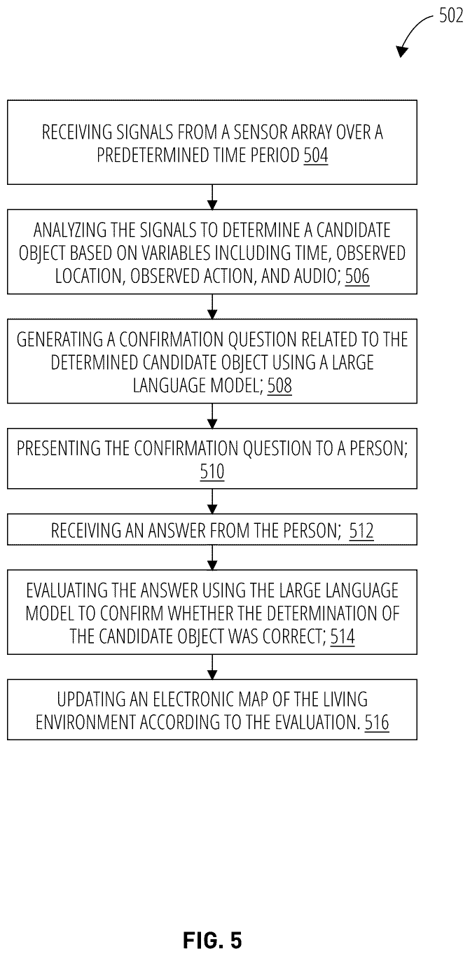

The Mapper 216 component shown in FIG. 2 corresponds directly to the functionality described in routine 502 (FIG. 5).

The Mapper 216 is a module within the processing environment 200 that works alongside the Processor 202, Tasks 210, Sensor 212, and I/O 214 components. The Mapper 216 is responsible for implementing the mapping functionality described in routine 502, which includes:
1. Receiving signals from a sensor array over a predetermined time period (504)
2. Analyzing the signals to determine candidate objects based on variables including time, observed location, observed action, and audio (506)
3. Generating confirmation questions related to determined candidate objects using a large language model (508)
4. Presenting confirmation questions to a person (510)
5. Receiving answers from the person (512)
6. Evaluating answers using the large language model to confirm whether determinations of candidate objects were correct (514)
7. Updating an electronic map of the living environment according to the evaluation (516)

The Mapper 216 utilizes data from the Sensor 212 module to collect the necessary signals and works with the I/O 214 module to present questions and receive answers from users. The mapping functionality enables the system to build and maintain an accurate representation of the living environment, which can then be used by the Tasks 210 module to detect trigger events associated with confirmed objects and initiate appropriate tasks.

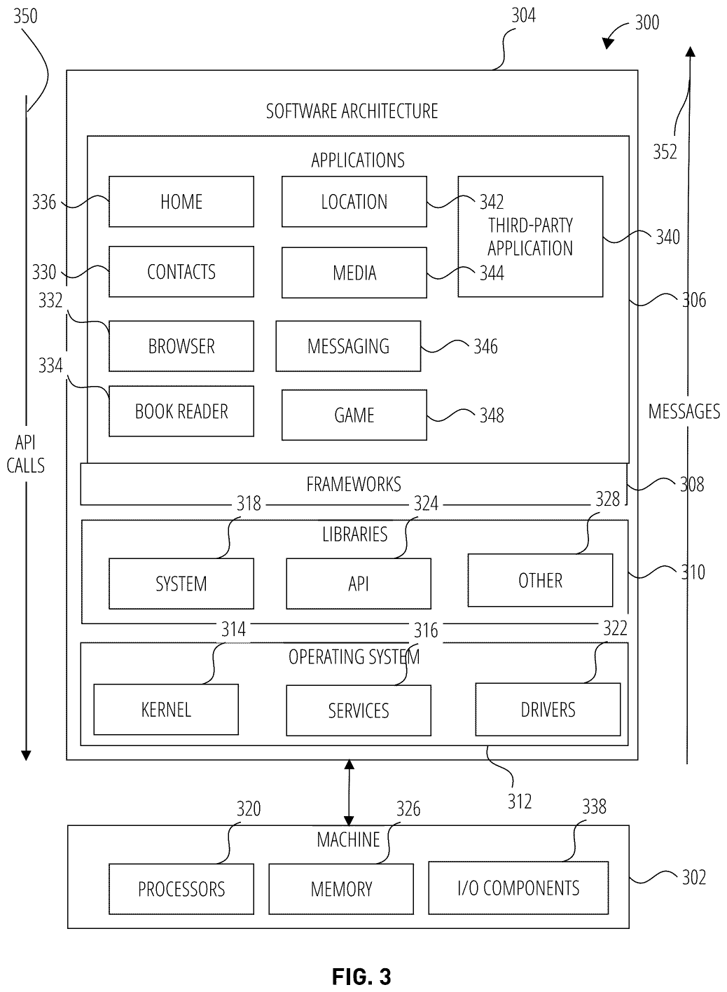

FIG. 3 is a block diagram 300 illustrating a software architecture 304, which can be installed on any one or more of the devices described herein. The software architecture 304 is supported by hardware such as a machine 302 that includes processors 320, memory 326, and I/O components 338. In this example, the software architecture 304 can be conceptualized as a stack of layers, where each layer provides a particular functionality. The software architecture 304 includes layers such as an operating system 312, libraries 310, frameworks 308, and applications 306.Operationally, the applications 306 invoke API calls 350 through the software stack and receive messages 352 in response to the API calls 350.

The operating system 312 manages hardware resources and provides common services. The operating system 312 includes, for example, a kernel 314, services 316, and drivers 322.The kernel 314 acts as an abstraction layer between the hardware and the other software layers. For example, the kernel 314 provides memory management, Processor management (e.g., scheduling), component management, networking, and security settings, among other functionalities. The services 316 can provide other common services for the other software layers. The drivers 322 are responsible for controlling or interfacing with the underlying hardware. For instance, the drivers 322 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, and power management drivers.

The libraries 310 provide a low-level common infrastructure used by the applications 306. The libraries 310 can include system libraries 318 (e.g., C standard library) that provide functions such as memory allocation functions, string manipulation functions, mathematic functions, and the like. In addition, the libraries 310 can include API libraries 324 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., Web Kit to provide web browsing functionality), and the like. The libraries 310 can also include a wide variety of other libraries 328 to provide many other APIs to the applications 306.

The frameworks 308 provide a high-level common infrastructure used by the applications 306. For example, the frameworks 308 provide various graphical user interface (GUI) functions, high-level resource management, and high-level location services. The frameworks 308 can provide a broad spectrum of other APIs that can be used by the applications 306, some of which may be specific to a particular operating system or platform.

In some examples, the applications 306 may include a home application 336, a contacts application 330, a browser application 332, a book reader application 334, a location application 342, a media application 344, a messaging application 346, a game application 348, and a broad assortment of other applications such as a third-party application 340.The applications 306 are programs that execute functions defined in the programs. Various programming languages can be employed to create one or more of the applications 306, structured in a variety of manners, such as object-oriented programming languages (e.g., Objective-C, Java, or C++) or procedural programming languages (e.g., C or assembly language).In a specific example, the third-party application 340 (e.g., an application developed using the ANDROID™ or IOS™ software development kit (SDK) by an entity other than the vendor of the particular platform) may be mobile software running on a mobile operating system such as IOS®, ANDROID®, WINDOWS® Phone, or another mobile operating system. In this example, the third-party application 340 can invoke the API calls 350 provided by the operating system 312 to facilitate functionality described herein.

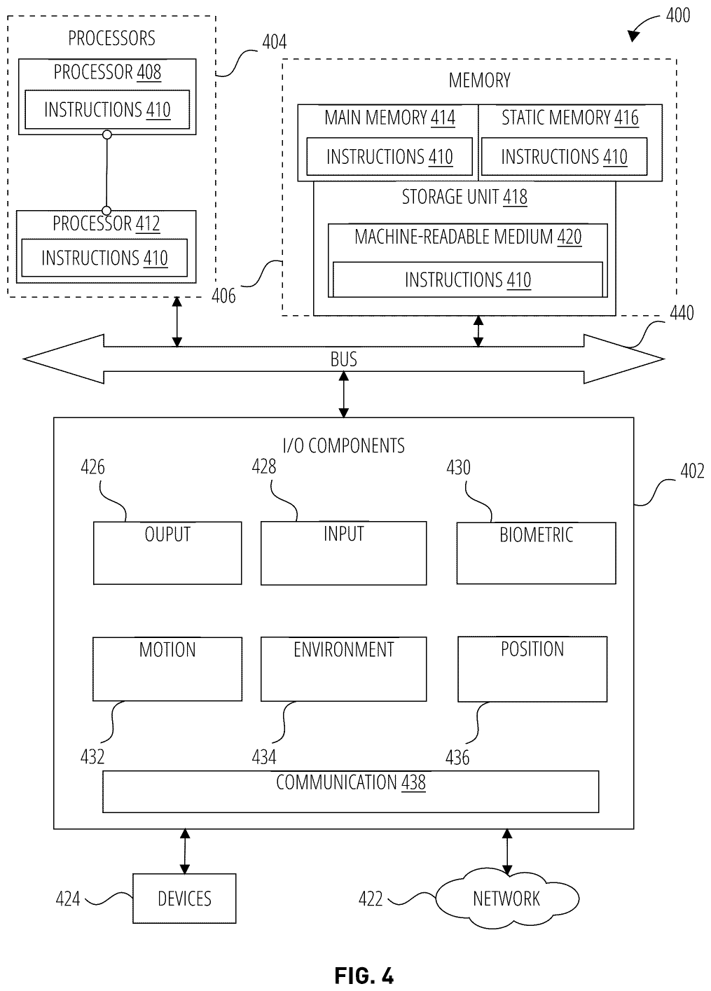

FIG. 4 is a diagrammatic representation of the machine 400 within which instructions 410 (e.g., software, a program, an application, an applet, an app, or other executable code) for causing the machine 400 to perform any one or more of the methodologies discussed herein may be executed. For example, the instructions 410 may cause the machine 400 to execute any one or more of the methods described herein. The instructions 410 transform the general, non-programmed machine 400 into a particular machine 400 programmed to carry out the described and illustrated functions in the manner described. The machine 400 may operate as a standalone device or be coupled (e.g., networked) to other machines. In a networked deployment, the machine 400 may operate in the capacity of a server machine or a client machine in a server-client network environment, or as a peer machine in a peer-to-peer (or distributed) network environment. The machine 400 may comprise, but not be limited to, a server computer, a client computer, a personal computer (PC), a tablet computer, a laptop computer, a netbook, a set-top box (STB), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 410, sequentially or otherwise, that specify actions to be taken by the machine 400. Further, while a single machine 400 is illustrated, the term “machine” may include a collection of machines that individually or jointly execute the instructions 410 to perform any one or more of the methodologies discussed herein.

The machine 400 may include processors 404, memory 406, and I/O components 402, which may be configured to communicate via a bus 440. In some examples, the processors 404 (e.g., a Central Processing Unit (CPU), a Reduced Instruction Set Computing (RISC)

Processor, a Complex Instruction Set Computing (CISC) Processor, a Graphics Processing Unit (GPU), a Digital Signal Processor (DSP), an Application-Specific Integrated Circuit (ASIC), a Radio-Frequency Integrated Circuit (RFIC), another Processor, or any suitable combination thereof) may include, for example, a Processor 408 and a Processor 412 that execute the instructions 410. The term “Processor” is intended to include multi-core processors that may comprise two or more independent processors (sometimes referred to as “cores”) that may execute instructions contemporaneously. Although FIG. 4 shows multiple processors 404, the machine 400 may include a single processor with a single core, a single processor with multiple cores (e.g., a multi-core processor), multiple processors with a single core, multiple processors with multiples cores, or any combination thereof.

The memory 406 includes a main memory 414, a static memory 416, and a storage unit 418, both accessible to the processors 404 via the bus 440. The main memory 406, the static memory 416, and storage unit 418 store the instructions 410 embodying any one or more of the methodologies or functions described herein. The instructions 410 may also reside, wholly or partially, within the main memory 414, within the static memory 416, within machine-readable medium 420 within the storage unit 418, within the processors 404 (e.g., within the processor's cache memory), or any suitable combination thereof, during execution thereof by the machine 400.

The I/O components 402 may include various components to receive input, provide output, produce output, transmit information, exchange information, or capture measurements. The specific I/O components 402 included in a particular machine depend on the type of machine. For example, portable machines such as mobile phones may include a touch input device or other such input mechanisms, while a headless server machine will likely not include such a touch input device. The I/O components 402 may include many other components not shown in FIG. 4. In various examples, the I/O components 402 may include output components 426 and input components 428. The output components 426 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), or other signal generators. The input components 428 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further examples, the I/O components 402 may include biometric components 430, motion components 432, environmental components 434, or position components 436, among a wide array of other components. For example, the biometric components 430 include components to detect expressions (e.g., hand expressions, facial expressions, vocal expressions, body gestures, or eye-tracking), measure biosignals via radar and/or other wireless or wired techniques (e.g., vital signs, including, but not limiting to: blood pressure, heart rate, body temperature, perspiration, or brain waves), or identify a person (e.g., voice identification, retinal identification, facial identification, fingerprint identification, radar identification, or electroencephalogram-based identification). The motion components 432 include acceleration sensor components (e.g., accelerometer), gravitation sensor components, rotation sensor components (e.g., gyroscope). The environmental components 434 include, for example, one or more cameras, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), radar sensor components or other components that may provide indications, measurements, or signals corresponding to a surrounding physical environment and persons, animals, and objects therein. The position components 436 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 402 further include communication components 438 operable to couple the machine 400 to a network 422 or devices 424 via respective coupling or connections. For example, the communication components 438 may include a network interface Component or another suitable device to interface with the network 422. In further examples, the communication components 438 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 424 may be another machine or any of a wide variety of peripheral devices (e.g., a peripheral device coupled via a USB).

Moreover, the communication components 438 may detect identifiers or include components operable to detect identifiers. For example, the communication components 438 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Data glyph, Maxi Code, PDF417, Ultra Code, UCC RSS-2D bar code, and other optical codes), or acoustic detection components (e.g., microphones to identify tagged audio signals). In addition, a variety of information may be derived via the communication components 438, such as location via Internet Protocol (IP) geolocation, location via Wi-Fi® signal triangulation, or location via detecting an NFC beacon signal that may indicate a particular location.

The various memories (e.g., main memory 414, static memory 416, and/or memory of the processors 404) and/or storage unit 418 may store one or more sets of instructions and data structures (e.g., software) embodying or used by any one or more of the methodologies or functions described herein. These instructions (e.g., the instructions 410), when executed by processors 404, cause various operations to implement the disclosed examples.

The instructions 410 may be transmitted or received over the network 422, using a transmission medium, via a network interface device (e.g., a network interface component included in the communication components 438) and using any one of several well-known transfer protocols (e.g., hypertext transfer protocol (HTTP)). Similarly, the instructions 410 may be transmitted or received using a transmission medium via a coupling (e.g., a peer-to-peer coupling) to the devices 424.

FIG. 5 illustrates an example routine for generating a map of a living environment. Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

According to some examples, the routine 502 includes receiving signals from a sensor array over a predetermined time period at block 504.

According to some examples, the routine 502 includes analyzing the signals to determine a candidate object based on variables including time, observed location, observed action, and audio at block 506.

According to some examples, the routine 502 includes generating a confirmation question related to the determined candidate object using a large language model at block 508.

According to some examples, the routine 502 includes presenting the confirmation question to a person at block 510.

According to some examples, the routine 502 includes receiving an answer from the person at block 512.

According to some examples, the routine 502 includes evaluating the answer using the large language model to confirm whether the determination of the candidate object was correct at block 514.

According to some examples, the method includes updating an electronic map of the living environment according to the evaluation at block 516.

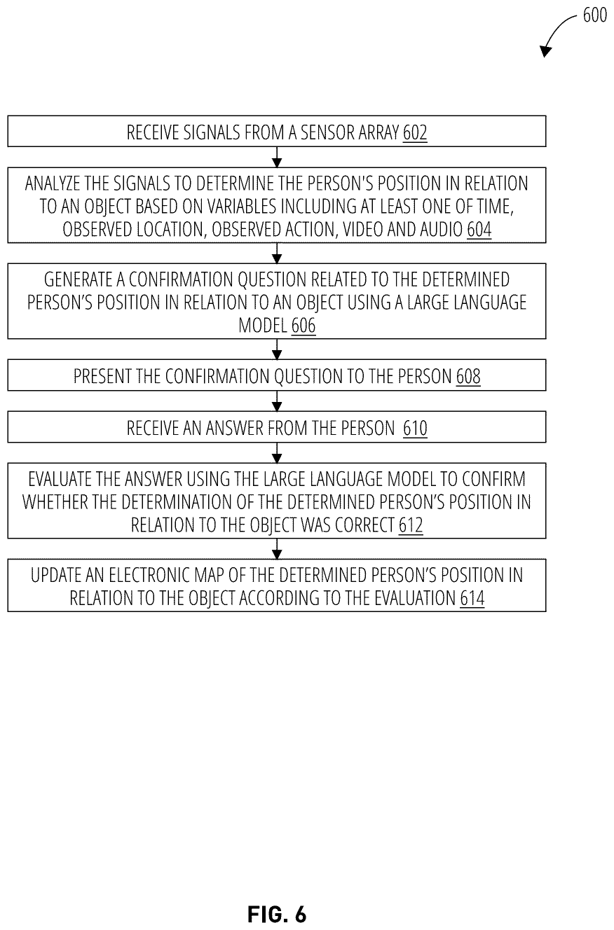

FIG. 6 illustrates a routine for determining a person's position in a living environment, in accordance with one example. In block 602, routine 600 receives signals from a sensor array. In block 604, routine 600 analyzes the signals to determine the person's position in relation to an object based on variables including at least one of time, observed location, observed action, video and audio. In block 606, routine 600 generates a confirmation question related to the determined person's position in relation to an object using a large language model. In block 608, routine 600 presents the confirmation question to the person. In block 610, routine 600 receives an answer from the person. In block 612, routine 600 evaluates the answer using the large language model to confirm whether the determination of the determined person's position in relation to the object was correct. In block 614, routine 600 updates an electronic map of the determined person's position in relation to the object according to the evaluation.

In block 702, routine 700 determines a trigger associated with a task has been met. In block 704, routine 700 determines, with a sensor, that a human has performed the task.

In an example, the sensor is a wireless sensor and the the wireless sensor determines the user has performed the task including one or more of moving to another location, sitting or standing up, moving their arms in specific patterns or breathing in specific ways

In an example, the determining if a trigger has been met uses a wireless sensor and the trigger includes one or more of user location, actions performed by the user including entering a room, leaving a bed, sitting down on a couch, waking up, turning on/off a light.

In an example, the trigger includes a current time, the task includes measuring vital signs of a human with the sensor and the sensor includes a radar. the task includes measuring vital signs of a human with the sensor and the sensor includes a radar. the task includes taking a medication and the sensor is a wireless sensor that observes the task being performed by the human. The task may comprise a care plan that includes one or more tasks.

The routine 700 may also comprise outputting a notification to the human that the task needs to be performed and/or transmitting information to a second device on a status or result of the task. The task may also include the human using a second device and the routine 700 further comprises confirming data has been collected from the second device.

The routine 700 may be performed after performance of the routine 502 and/or routine 600 or independently.

### Example 1: Bedroom Mapping

A sensor array is installed in a bedroom and collects signals over a period of three nights. The system detects a pattern where a person lies down in the same location each night around 10:00 PM and remains relatively stationary until approximately 7:00 AM. The radar sensors capture point clouds showing the person's position, and the microphones detect periodic snoring sounds during these hours. Based on this data, the system determines that the location is likely a bed.

The next morning after the person gets up, the system generates a question using its large language model: “How did you sleep last night?” When the person responds “I slept well, thanks for asking,” the system evaluates this response and confirms with high confidence that the object is indeed a bed. The system then updates its electronic map of the living environment to mark this location as a bed.

### Example 2: Kitchen Identification

Over several days, the sensor array detects a person standing in a particular area of the home during specific times (morning, noon, and evening). The sensors capture sounds of water running, pots and pans clanging, and occasional beeping of electronic devices. Based on these variables, the system determines that this area is likely a kitchen with various appliances.

To confirm, the system generates the question: “Did you enjoy cooking dinner last night?” When the person responds “Yes, I made pasta,” the large language model evaluates this response as confirming the kitchen determination. The system updates its map accordingly, marking the location of various kitchen elements including the refrigerator that was detected based on the person's repeated interactions with it.

### Example 3: Task Triggering and Monitoring

After mapping the living environment and confirming object locations, the system is programmed with a medication reminder task. The trigger condition is set as “person leaves bed after 8:00 AM.” One morning, when the person gets out of bed at 8:30 AM, the system detects this trigger event and activates the medication reminder task.

The system announces: “Good morning! Don't forget to take your morning medication.” Using its radar sensors, the system then monitors whether the person approaches the cabinet near the refrigerator where medications are stored. When the person opens the cabinet and takes something out, the system determines through its radar sensing capabilities that the task has likely been completed. The system records this task completion in its database for later review.

### Example 4: Position Determination and Confirmation

The sensor array detects that the person has moved to a specific location in the living room and has remained seated for an extended period. The system also detects audio that matches television programming. Based on these observations, the system determines that the person is sitting on what is likely a couch or chair watching television.

To confirm this determination, the system generates the question: “Are you enjoying the show you're watching?” When the person responds “Yes, this documentary is fascinating,” the system evaluates this response using its large language model and confirms that the person is indeed watching television in a sitting area. The system updates its map to mark this location as a television viewing area with seating.

### Example 5: Adaptive Task Reminders

The system is programmed with an exercise reminder task with a trigger condition of “weekday mornings after breakfast.” One morning, the system detects that the person has finished breakfast (based on their movements away from the dining area and the cessation of eating-related sounds). This triggers the exercise reminder.

However, the person ignores the initial reminder and continues with other activities. The system notes this lack of response and, when the person returns to the living room later, repeats the reminder: “Don't forget about your morning exercises.” When the person then performs stretching movements, the radar sensors detect these specific motions and the system determines that the exercise task has been completed, recording this information in its database.

Another set of examples follows:
1. A method for determining a person's position in a living environment, comprising:
   receiving signals from a sensor array;
   analyzing the signals to determine the person's position in relation to an object based on variables including at least one of time, observed location, observed action, video and audio;
   generating a confirmation question related to the determined person's position in relation to an object using a large language model;
   presenting the confirmation question to the person;
   receiving an answer from the person;
   evaluating the answer using the large language model to confirm whether the determination of the determined person's position in relation to the object was correct; and
   updating an electronic map of the determined person's position in relation to the object according to the evaluation.
2. The method of any of the previous examples, wherein the sensor array comprises at least one radar sensor, and the observed location comprises point clouds from radar returns.
3. The method of any of the previous examples, wherein determining the determined person's position in relation to the object comprises:
   detecting a pattern of human activity occurring at a consistent location over multiple instances; and
   correlating the pattern with characteristic sensor data associated with the human activity.
4. The method of example 3, wherein the pattern of human activity comprises a person lying down and the characteristic sensor data includes audio of snoring, and wherein the object is determined to be a bed.
5. The method of any of the previous examples, wherein the confirmation question is contextually relevant to an expected use of the object.
6. The method of any of the previous examples, wherein evaluating the answer comprises:
   analyzing semantic content of the answer to determine whether it is consistent with the expected use of the object or determined person's position in relation to the object; and
   updating a confidence score associated with the object or determined person's position in relation to the object based on the analysis.
7. The method of any of the previous examples, wherein the variables further include temporal patterns of usage of the object.
8. The method of any of the previous examples, further comprising:
   detecting a trigger event associated with the object; and
   initiating a task in response to the trigger event.
9. The method of example 8, wherein the task includes the person using a device and the method further comprises confirming data has been collected from the device.
10. The method of example 8, wherein the detecting if a trigger has been met uses a wireless sensor and the trigger includes one or more of user location, actions performed by the user including entering a room, leaving a bed, sitting down on a couch, waking up, turning on/off a light.
11. A non-transitory computer-readable medium having stored thereon instructions to configure at least one processor to execute any of examples 1-10.

A system, comprising:
a sensor array configured to receive signals;
at least one processor; and
a non-transitory computer-readable medium having stored thereon instructions to configure the at least one processor to executed any of the examples 1-10.

### Glossary

“Carrier Signal” refers to any intangible medium capable of storing, encoding, or carrying instructions for execution by the machine, and includes digital or analog communications signals or other intangible media to facilitate communication of such instructions. Instructions may be transmitted or received over a network using a transmission medium via a network interface device.

“Communication Network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High-Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner In examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. A decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of methods described herein may be performed by one or more processors 1004 or processor-implemented components. Moreover, the one or more processors may also operate to support performance of the relevant operations in a “cloud computing” environment or as a “software as a service” (SaaS).For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In some examples, the processors or processor-implemented components may be distributed across a number of geographic locations.

“Computer-Readable Medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine-Storage Medium” refers to a single or multiple storage devices and/or media (e.g., a centralized or distributed database, and/or associated caches and servers) that store executable instructions, routines and/or data. The term includes solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium”, “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Module” refers to logic having boundaries defined by function or subroutine calls, branch points, Application Program Interfaces (APIs), or other technologies that provide for the partitioning or modularization of particular processing or control functions. Modules are typically combined via their interfaces with other modules to carry out a machine process. A module may be a packaged functional hardware unit designed for use with other components and a part of a program that usually performs a particular function of related functions. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein. In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations. Accordingly, the phrase “hardware module” (or “hardware-implemented module”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time. Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information). The various operations of example methods and routines described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors. Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal Medium” refers to any intangible medium that is capable of storing, encoding, or carrying the instructions for execution by a machine and includes digital or analog communications signals or other intangible media to facilitate communication of software or data. The term “signal medium” may o include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

What is claimed is:

1. A method for determining a person's position in a living environment, comprising:
receiving signals from a sensor array;
analyzing the signals to determine the person's position in relation to an object based on variables including at least one of time, observed location, observed action, video and audio;
generating a confirmation question related to the determined person's position in relation to the object using a large language model;
presenting the confirmation question to the person;
receiving an answer from the person;
evaluating the answer using the large language model to confirm whether the determination of the determined person's position in relation to the object was correct; and
updating an electronic map of the determined person's position in relation to the object according to the evaluation.

2. The method of claim 1, wherein the sensor array comprises at least one radar sensor, and the observed location comprises point clouds from radar returns.

3. The method of claim 1, wherein determining the determined person's position in relation to the object comprises:
detecting a pattern of human activity occurring at a consistent location over multiple instances; and
correlating the pattern with characteristic sensor data associated with the human activity.

4. The method of claim 3, wherein the pattern of human activity comprises a person lying down and the characteristic sensor data includes audio of snoring, and wherein the object is determined to be a bed.

5. The method of claim 1, wherein the confirmation question is contextually relevant to an expected use of the object.

6. The method of claim 1, wherein evaluating the answer comprises:
analyzing semantic content of the answer to determine whether it is consistent with an expected use of the object or determined person's position in relation to the object; and
updating a confidence score associated with the object or determined person's position in relation to the object based on the analysis.

7. The method of claim 1, wherein the variables further include temporal patterns of usage of the object.

8. The method of claim 1, further comprising:
detecting a trigger event associated with the object; and
initiating a task in response to the trigger event.

9. The method of claim 8, wherein the task includes the person using a device and the method further comprises confirming data has been collected from the device.

10. A non-transitory computer readable medium having stored thereon instructions to configure a computer to:
receive signals from a sensor array;
analyze the signals to determine a person's position in relation to an object based on variables including at least one of time, observed location, observed action, video and audio;
generate a confirmation question related to the determined person's position in relation to the object using a large language model;
present the confirmation question to the person;
receive an answer from the person;
evaluate the answer using the large language model to confirm whether the determination of the determined person's position in relation to the object was correct; and
update an electronic map of the determined person's position in relation to the object according to the evaluation.

11. A system, comprising:
a sensor array configured to receive signals;
at least one processor; and
a non-transitory computer-readable medium having stored thereon instructions to configure the at least one processor to:
analyze the signals to determine a person's position in relation to an object based on variables including at least one of time, observed location, observed action, video and audio;
generate a confirmation question related to the determined person's position in relation to the object using a large language model;
present the confirmation question to the person;
receive an answer from the person;
evaluate the answer using the large language model to confirm whether the determination of the determined person's position in relation to the object was correct; and
update an electronic map of the determined person's position in relation to the object according to the evaluation.

12. The system of claim 11, wherein the sensor array comprises at least one radar sensor, and the observed location comprises point clouds from radar returns.

13. The system of claim 11, wherein determining the determined person's position in relation to the object comprises:
detecting a pattern of human activity occurring at a consistent location over multiple instances; and
correlating the pattern with characteristic sensor data associated with the human activity.

14. The system of claim 13, wherein the pattern of human activity comprises a person lying down and the characteristic sensor data includes audio of snoring, and wherein the object is determined to be a bed.

15. The system of claim 11, wherein the confirmation question is contextually relevant to an expected use of the object.

16. The system of claim 11, wherein evaluating the answer comprises:
analyzing semantic content of the answer to determine whether it is consistent with an expected use of the object or determined person's position in relation to the object; and
updating a confidence score associated with the object or determined person's position in relation to the object based on the analysis.

17. The system of claim 11, wherein the variables further include temporal patterns of usage of the object.

18. The system of claim 11, wherein the instructions further configure the at least one processor to:
detect a trigger event associated with the object; and
initiate a task in response to the trigger event.

19. The system of claim 18, wherein the task includes the person using a device and the instructions further configure the at least one processor to confirm data has been collected from the device.

20. The system of claim 18, wherein the detecting if a trigger has been met uses a wireless sensor and the trigger includes one or more of user location, actions performed by the user including entering a room, leaving a bed, sitting down on a couch, waking up, turning on/off a light.
